(19) United States
(12) Patent Application Publication
(10) Pub. No.: US 2011/0080004 A1
(43) Pub. Date: Apr. 7, 2011

(54) RENEWABLE ENERGY GENERATION ECO SYSTEM

(76) Inventor: Altaf Hadi, Murphy, TX (US)

(21) Appl. No.: 12/736,722

(22) PCT Filed: May 4, 2009
(86) PCT No.: PCT/US2009/042736

§ 371 Date: Nov. 3, 2010

Related U.S. Application Data
(60) Provisional application No. 61/126,685, filed on May 6, 2008.

(51) Int. Cl. F03D 9/00; F03G 7/10

(52) U.S. Cl. 290/55; 74/DIG. 9

(57) ABSTRACT

In one embodiment, a renewable energy generation eco system includes a magnetic guideway for the propulsion of a non contact levitating vehicle mounted with one or more wind turbines travelling at constant or at a variable speed; the incoming wind rotates the mounted turbine blades due to its kinetic energy thus providing torque to generators producing renewable electricity for residential, commercial, agricultural, industrial and transportation use. In another embodiment, a renewable energy generation eco system includes a wheel based runway for the propulsion of wheel based vehicle mounted with one or more wind turbines travelling at constant or at a variable speed; the incoming wind rotates the mounted turbine blades due to its kinetic energy thus providing torque to generators producing renewable electricity for residential, commercial, agricultural, industrial and transportation use.

### TECHNICAL FIELD OF THE INVENTION

This invention relates generally to renewable energy generation and more particularly to generating electricity for residential, commercial, agricultural, industrial and transportation use.

### BACKGROUND OF THE INVENTION

Energy generated from renewable sources such as wind cannot be generated at all locations around the world where wind blowing at substantial speed to turn the turbine blades is not available. Also, electricity generated from present day wind turbines is used as a supplement to existing electricity generating sources that cause the build-up of green houses gases in the environment. The present innovation teaches a novel way to generate electricity continuously at all locations around the world to be use as the main source of electricity for residential, commercial, agricultural, industrial and transportation use

In today's world energy has become such a basic necessity of life, so much so, food on a large scale is being diverted to create energy supplement in the form of ethanol. Increasingly, governments are mandating the use of ethanol as fuel supplement to reduce environmental pollution. On Mar. 12, 2008, a major world news journal, The Washington Post, published an article written by the current Secretary General of UN, Ban Ki Moon, titled “The New Face of Hunger” highlighting the plight of the 73 million hungry people worldwide. And on Apr. 11, 2008 the World Bank Web site posted comments from the bank's president, Robert B. Zoellick who stated “the crisis of surging food prices could mean seven lost years in the fight against world poverty”.

As more and more grain and other agricultural produce get diverted to produce fuel supplements, the price of food may sky rocket beyond the reach of the world's poor. These troubles are beginning to manifest in many third world and developing countries around the world; even the top industrial nations such as the United States and Japan are facing steep food price increases.

The diversion of food to produce energy supplements while aggravating the world hunger issue is neither making a significant impact in meeting the transportation energy requirements nor affectively addressing the global pollution problem. Every day human beings are contributing more green-house gases to the environment by burning increasing amounts of fossil fuels. Coal, another fossil fuel used in the generation of electricity is also contributing extensively to the environmental pollution.

As the environmental pollution and world hunger is rising, so is the demand for energy. Humanity at large is consuming ever increasing quantities of energy thereby driving all form of energy prices higher at a rapid pace creating hyper inflation. Countries such as India and Philippines have begun to curb the export of grains to meet local needs. Food riots in Pakistan, Egypt and many Latin American countries are becoming a norm forcing governments' to subsidize food to sustain a hungry populace; these subsidies are diverting valuable resources from developing their nation's infrastructure. Such is the enormity of this problem that if not checked timely, it has the potential to unleash unprecedented starvation and political upheaval on a global scale—in other words the perfect storm of the 21^{st} century is brewing rapidly.

The present invention describes a novel way to produce clean energy from renewable sources for residential, commercial, agricultural, industrial and transportation use. The novelty of this invention is that clean renewable energy can be produced locally at any place on the globe and around the clock without dependency on wind, water or sunshine.

These and other objects and advantages will come to view and be understood upon a reading of the detailed description when taken in conjunction with the accompanying drawings.

### SUMMARY OF THE INVENTION

A renewable energy eco system for producing electricity which harnesses power from the blades of moving wind turbine(s) racing against the wind. Depending upon the operating environment, the wind turbines move on guided non contact levitation and propulsion system or wheel based propulsion system at constant or variable speed converting the kinetic energy of the incoming wind to rotate its blades thereby driving direct drive and\or shaft driven generators to produce electricity. The electricity thus produced can be used for residential, commercial, agricultural, industrial and transportation use.

### BRIEF DESCRIPTION OF THE DRAWINGS

While the making and using of various embodiments of the present invention are discussed in detail below, it should be appreciated that the present invention provides many applicable inventive concepts that may be embodied in a wide variety of specific contexts. The specific embodiments discussed herein are merely illustrative of specific ways to make and use the invention and do not delimit the scope of the invention.

FIG. 1 illustrates an example renewable energy generation eco system.

FIG. 2A illustrates an example of a magnetic guideway.

FIG. 2B is an example of multiple wind turbines mounted on a non-contact propulsion vehicle illustrating known principles of magnetic and electro-magnetic interactions providing levitation and lateral control for the generation of electricity.

FIG. 2C illustrates a perspective view of a non-contact levitation and propulsion vehicle travelling on a magnetic guideway with a mounted wind turbine.

FIG. 2D illustrates a frontal view of a wind turbine mounted on a non-contact propulsion vehicle levitating by means of superconductor based magnetic levitation.

FIGS. 3A, 3B and 3C illustrates examples of runways for wheel based propulsion vehicles.

FIG. 3D illustrates a perspective view of a wind turbine mounted on a wheel based propulsion vehicle.

FIG. 3E illustrates a perspective view of a renewable energy generation eco system on a body of water.

FIGS. 4A, 4B, 4C, 4D, 4E and 4F illustrates example designs of wind turbine blades.

FIGS. 5A and 5B illustrates an example mechanism for collecting electricity produced from the wind turbines.

FIG. 6 illustrates a computer based electronic wind turbine, guideways/runways and vehicle propulsion control logic system.

### DETAILED DESCRIPTION OF EXAMPLE EMBODIMENTS

As used herein, the functional terminology of [i] energy and electricity are used interchangeably [ii] computer based and electronic are used interchangeably [iii] incoming wind and oncoming wind are used interchangeably [iv] moving and travelling are used interchangeably.

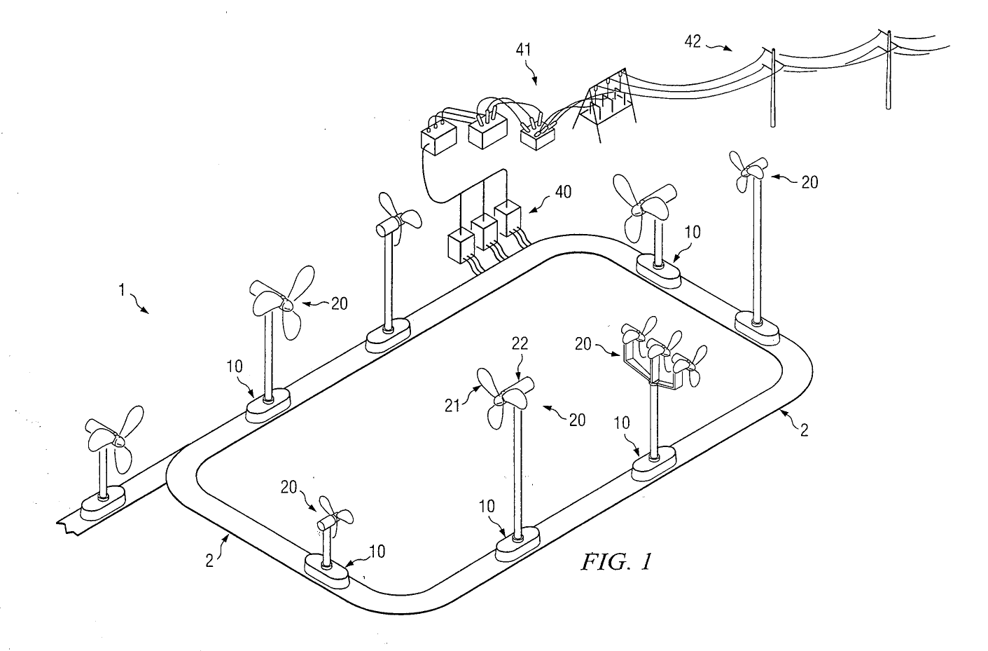

FIG. 1 illustrates an example renewable energy eco system 1 comprising of guideway or runway 2 with propulsion vehicles 10 mounted with one more wind turbines 20 moving against the incoming wind (not shown). The kinetic energy (not shown) of the oncoming wind rotates the turbine blades 21 of the mounted wind turbines 10, the rotating turbine blades 21, by means of the drive train (not shown) provide torque to the generators (not shown) located in the nacelle 22 producing electricity. The electricity thus produced is harvested at collection boxes 40 and switched to high voltage electrical subsystem 41; the electricity is thus converted to high voltage electricity by means of the transformers present in the electrical subsystem 41 and then transported over the public or private grids 42 to be used for residential, commercial, agricultural, industrial, and transportation use.

The power generated by a stationary wind turbine is governed by the formula

P=0.5 rho AV³CₚNgN_{d}

where
P=power in watts
rho=air density in Kg/m³ (about 1.225 kg/m³ at sea level, less higher up)
A=rotor swept area, exposed to the wind (m²)
Cp=Coefficient of performance
V=wind speed in meters/sec
Ng=generator efficiency
Nb=gearbox/bearings efficiency

Air density rho at sea level is approximately 1.225 kg/m³, the density of air falls at higher altitudes. Cp is the co-efficient of performance based on Betz law; said Betz law states that the theoretical maximum energy harvested from the wind is 16/27 or 0.59. For a well designed modern day wind turbine the Co-efficient of performance can be as high as 0.35 while the generator efficiency can be greater than 80% and the drive train or the gearbox efficiency can be 95%.

In the renewable energy eco system 1 the value of the coefficient of performance Cₚ¹ can vary with respect to the coefficient of performance of Cₚ of a stationary wind turbine. In the renewable energy eco system 1, the coefficient of performance Cₚ¹ is acted upon by the operational characteristics of a moving wind turbine 20 at constant or variable speeds against the incoming wind. The said value of co-efficient of performance Cₚ¹ for a given combination of propulsion vehicle 10 and mounted wind turbines 20 can be equal to or vary from that of coefficient performance Cp of a stationary turbine; for a given value of Cₚ¹, the energy yield for wind turbines of the energy eco system 1 is governed by the formula 0.5 rho AV³Cₚ¹NgN_{d}; said energy yield for a given wind turbine 20 can be computed over a defined kilo watt hour range.

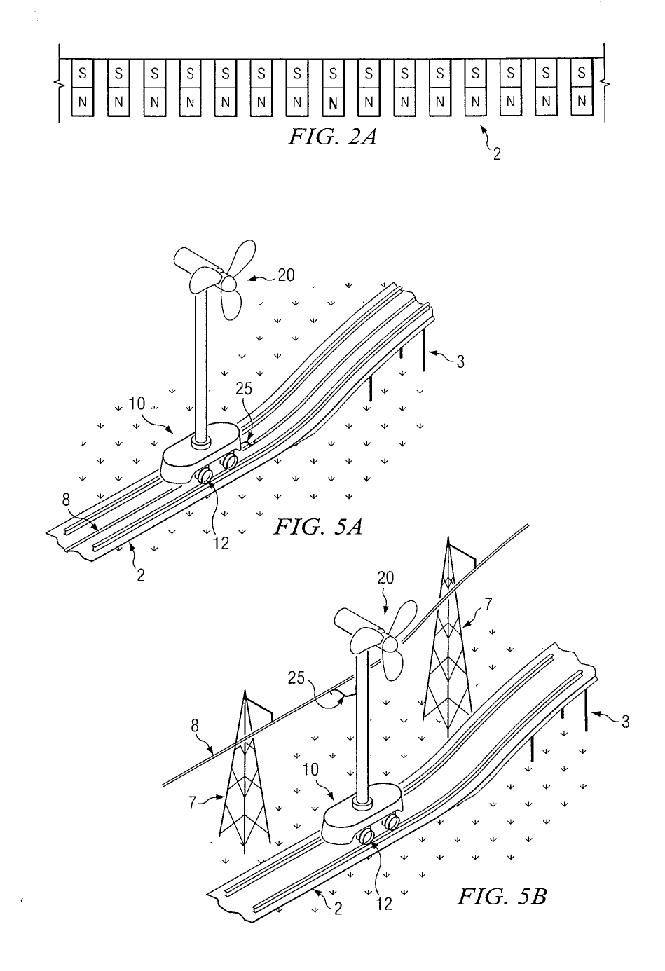

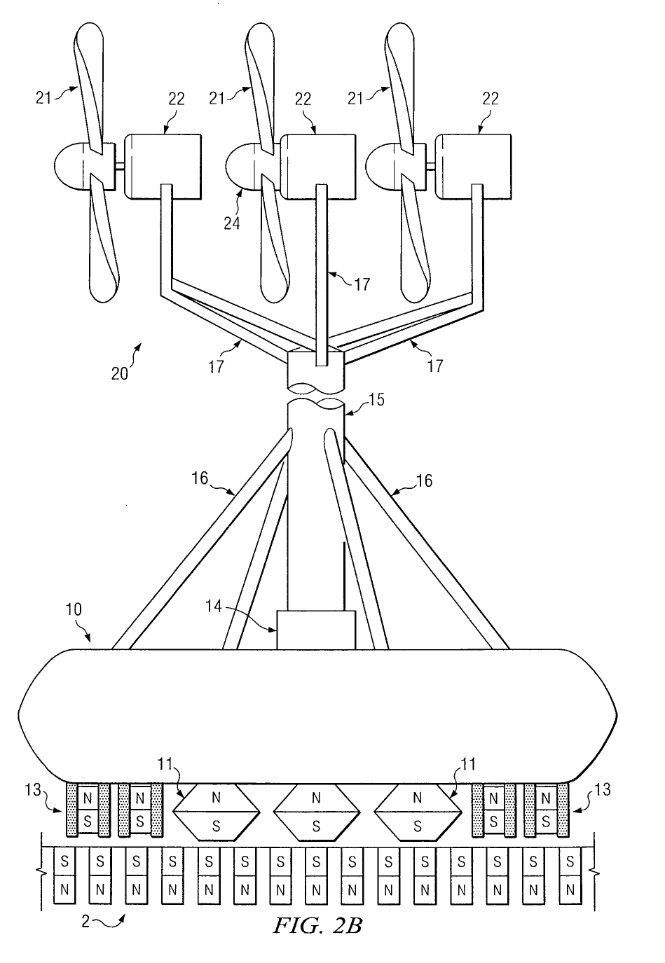

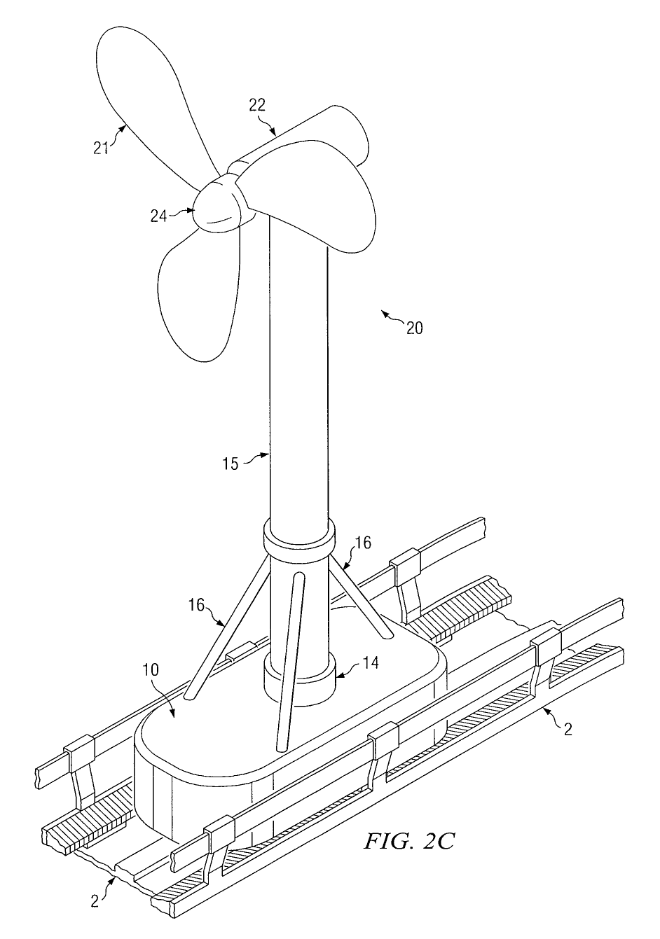

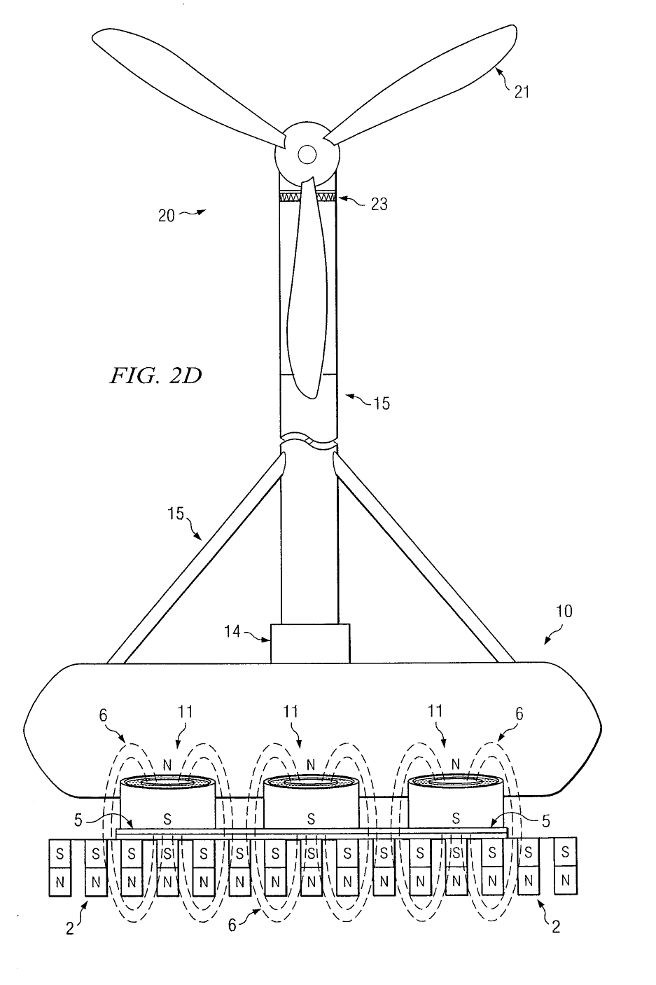

FIG. 2A illustrates an example of a magnetic guideway 2 used for the propulsion of non-contact levitated propulsion vehicles. Said magnetic guideway comprising of one or more arrays of magnets, preferably permanent magnets, and disposed along the length of the guideway is\are laid out in Hallbach array configuration having a plurality of equally spaced magnetic elements whose upper side having the same polarity with that of the magnets in the bottom side of the propulsion vehicle 10 thus creating repulsive magnetic forces necessary for the levitation of said propulsion vehicles 10.

FIG. 2B is an example of multiple wind turbines mounted on a non-contact propulsion vehicle illustrating known principles of magnetic and electro-magnetic interactions providing levitation and vertical control. A plurality of load bearing magnets 11 are spacedly disposed on the underside of the propulsion vehicle 10 in a variety of configurations including the Hallbach array configuration to provide the necessary magnetic repulsive forces interacting with the guideway 2 to levitate the propulsion vehicle 10. As described by Fiske et al in the U.S. Pat. No. 6,684,794, the combination of magnets, preferably permanent magnets, and control coils 13, provides yaw and lateral control of the said propulsion vehicle 10—the control yaw and the lateral control generally referred to as the lateral control. Also as described in Fiske et al, in U.S. Pat. No. 6,684,794, said combination of said magnets and control coils 13 are spacedly displaced along the underside edges of the propulsion vehicle 10 for the propulsion and control of the propulsion vehicle 10 along the length of the guideway 2. Thus the overall combination of the guideway 2 composing of magnets, preferably permanent magnets, laid out in a singular or plural Hallbach array format, the load bearing magnets 11 so arranged on the underside carriage of the propulsion vehicle 10 and the combination of magnets and control coils 13 so arranged across the edges of the underside carriage of the propulsion vehicle 10 displays known principles of magnetism and electromagnetism for the levitation, propulsion and lateral control of the propulsion vehicle 10 across the length of the guideway 2.

Generally, as illustrated in FIG. 2B, the wind turbines 20 are erected on a main tower assembly 15 on the propulsion vehicle 10. The main tower assembly 15 is secured to the propulsion vehicle 10 by means of foundational support templates 14 and support towers 16. A plurality of wind turbines can then be mounted in a variety of configurations by means of support structures 17; in a particular embodiment, the nose cones 24 of the trailing wind turbine may face the nacelle 24 of the leading wind turbine; in yet another embodiment, the nose cones 24 of the plurality of the wind turbines so mounted on the main tower assembly 15 may face in the direction looking into the page [not shown] or out of the page [not shown] to rotate the turbine blades 21 in an upward wind configuration or in a downward wind configuration. In a configuration whereby there is one wind turbine assembly, said wind turbine assembly is mounted on the main tower assembly 15. Said direction of the nose cones 24 can be rotated in the desired direction for an upwind configured wind turbine or a downwind configured wind turbine by means of the yaw mechanism 23 as illustrated in FIG. 2D.

The load of the main tower assembly 15 of the wind turbine 20 is disposed across the load bearing magnets 11 of the propulsion vehicle 10; said load bearing magnets 11, preferably permanent magnets, generate a majority of the lift required to levitate the propulsion vehicle 10 relative to the magnetic guideway 2. As disclosed by Fiske et al in U.S. Pat. No. 6,684,794, while assisting in the levitation of the propulsion vehicle 10, the primary purpose of the guidance electromagnets 13 is for lateral control and/or vertical damping.

In another embodiment, the load bearing support magnets 11 along with the guidance electro magnets 13 are spacedly disposed on either side of the propulsion vehicle 10 based on the well known Transrapid Maglev design [not shown]. The support magnets 11 provide the lift to levitate the propulsion vehicle 10 while the guidance magnets 13 hold it laterally on tracks. In this configuration, the guideway arrays of magnets (not shown) are located on the flip side of the guideway not facing the underside of the propulsion vehicle 10. In such a Transrapid Maglev design, the load of the main tower assembly 15 is distributed across the edges (not shown).

In the aforementioned configurations, the propulsion vehicle 10 is propelled and braked by a synchronous long stator linear motor (not shown) located in the guideway 2. When energized, an electromagnetic travelling magnetic field is generated in the windings of the said stator propelling the vehicle along the guideway without contact. In this way, the propulsion vehicle 10 travels along the guideway. Thus the non-contact vehicle 10 while levitating is propelled along the magnetic guideway 2 against the oncoming wind converting its kinetic energy to rotate the turbine blades 21 providing torque to generators producing electricity.

In another embodiment as illustrated in FIG. 2D, the load bearing magnets of FIG. 2B are replaced with conventional material blocks that exhibits super conductivity when cooled below a reference temperature. The load bearing superconducting material blocks 11 are cast in a way to have hollow spaces within them for the storage of liquids, such as but not limited to liquid nitrogen, to cool the load bearing material to specific temperature, for example −183 degree Celsius for certain types of ceramics. To prevent the loss of the super conducting liquid from the surface of the superconducting material due to evaporation, the super conducting material may be enclosed or wrapped in casing (not shown) to prevent loss by evaporation. The wrapper casing will be made of passive material so as not to interfere with the operations of the said preferred embodiment.

In the example embodiment of FIG. 2D, the load bearing superconducting material blocks 12 are placed on magnetic guideway 2 constructed of conventional magnets, preferably permanent magnets, arranged in specific array configuration of the example type Hallbach array configuration. The load bearing superconducting blocks 11 are initially placed on top of removable shims 5 of certain thickness on the guideway 2. Superconducting liquid is then pumped into load bearing super conducting blocks 11 such that the cooling liquid permeates through the mass of the superconducting blocks 11. As the temperature of the superconducting material blocks 11 fall below their specific reference temperature, they exhibit super conductivity and trap the magnetic flux 6 of the magnetic guideway below, so as to generate sufficient repulsive magnetic force to levitate the propulsion vehicle 10 on the magnetic guideway 2. The intermediary shims 5 are then removed; the load bearing superconducting blocks 11 thus generates sufficient repulsive magnetic force so as to levitate the propulsion 10 on the magnetic guideway 2 as illustrated in FIG. 2D.

The superconductor based levitating propulsion vehicle 10 of FIG. 2D can be front ended and back ended with the magnetic propulsion and vertical control as described in FIG. 2B for propelling the superconductor based levitating propulsion vehicle along the length of the magnetic guideway 2. The purpose of such a hybrid levitation vehicle is to assist in the levitation of the propulsion vehicle and to provide lateral control and damping; the primary purpose of such a hybrid configuration is to provide propulsion to the levitating vehicle by means of a synchronous long stator linear motor located in the guideway. Once energized, an electromagnetic travelling magnetic field is generated in the windings of the said stator propelling superconductor based hybrid propulsion vehicle along the guideway without contact. Once the vehicle reaches the desired speed, the synchronous long stator linear motor present in the guideway can be disconnected from the energy source. The superconducting blocks memorizes the path to travel along the guideway and thus while levitating propels the vehicle along the guideway without further propulsion aid by virtue of the flux trapped 6 between the superconducting blocks and the magnetic guideway.

Conversely, the superconductors based levitation vehicle can be constructed in a hybrid format with a backend wheel based propulsion system (not shown). In such a configuration, the propulsion path is constructed of a hybrid magnetic guideway and runway (not shown). The wheels extend on either side of the magnetic guideway on the wheel runway. The wheel based propulsion system propels the superconducting material based levitating vehicle to a desired speed and can be then disconnected. The superconducting blocks memorizes the path to travel and thus while levitating propels the vehicle along the guideway without further propulsion aid by virtue of the flux trapped between the superconducting blocks and the magnetic guideway.

Thus the said superconducting material based non-contact levitation vehicle as illustrated in FIG. 2D with mounted wind turbine 20 is propelled along the magnetic guideway 2 by virtue of the flux 6 trapped between the superconducting material based load bearing magnets 11 and the magnetic guideway 2 against the oncoming wind converting its kinetic energy to rotate the turbine blades 21 providing torque to generators producing electricity.

FIG. 2C illustrates a perspective view of a non contact propulsion vehicle 10 travelling on the magnetic guideway 2 at constant speed or at a variable speed; the incoming wind cause the mounted turbine blades 21 to rotate due to the force exerted by the kinetic energy of the incoming wind providing torque to generators located in the nacelle 22 thus producing electricity. The energy yield for the said wind turbine of FIG. 2C is governed by the formula 0.5 rho AV³Cₚ¹NgN_{d}; the energy yield can be computed over a defined kilo watt hour range.

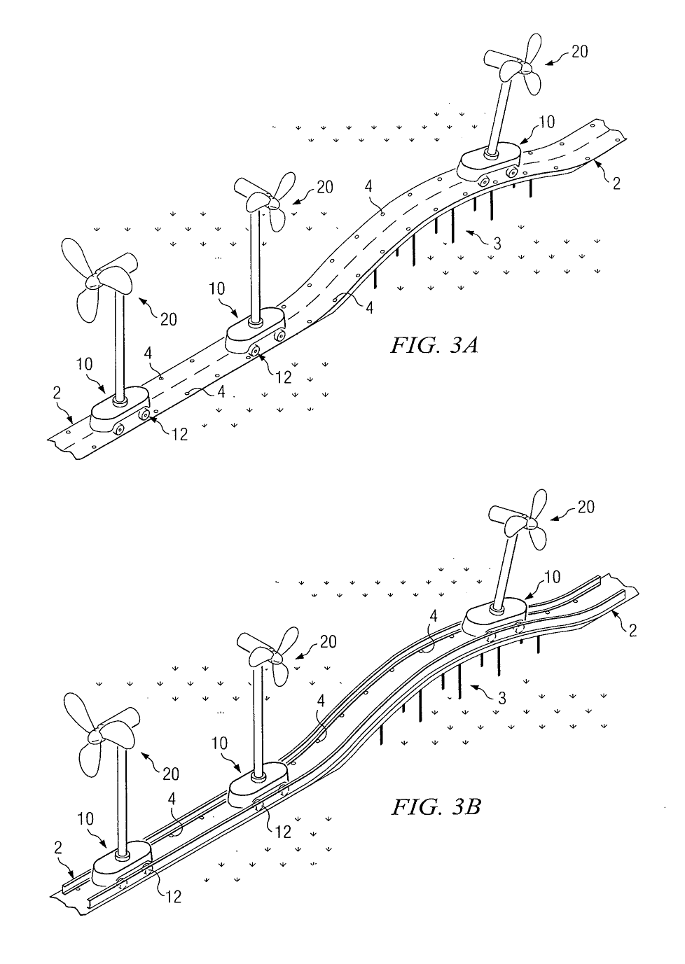

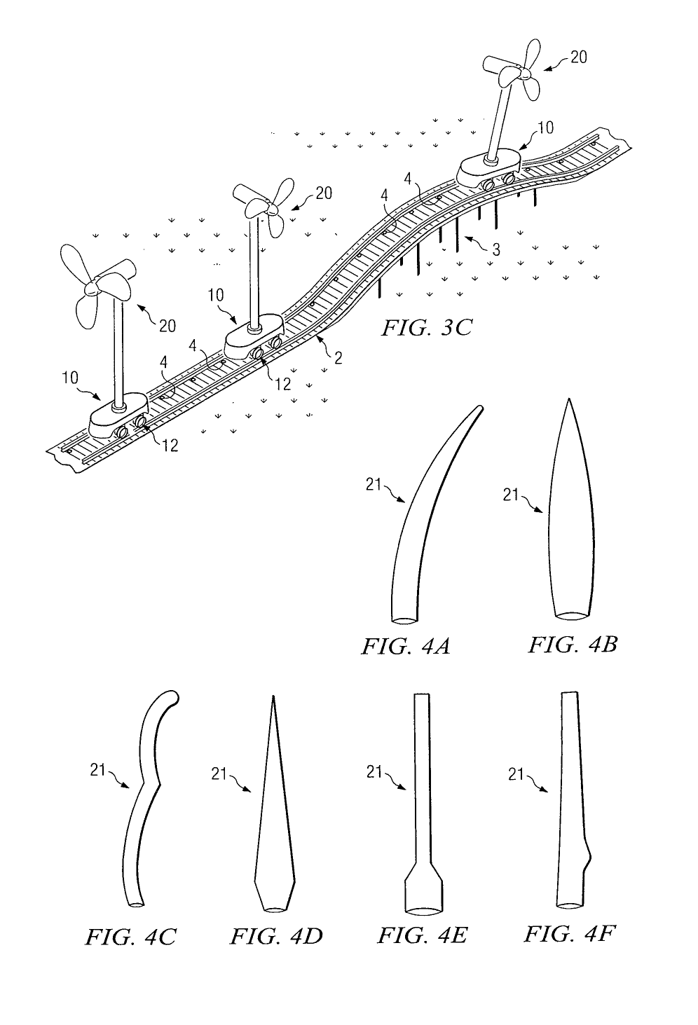

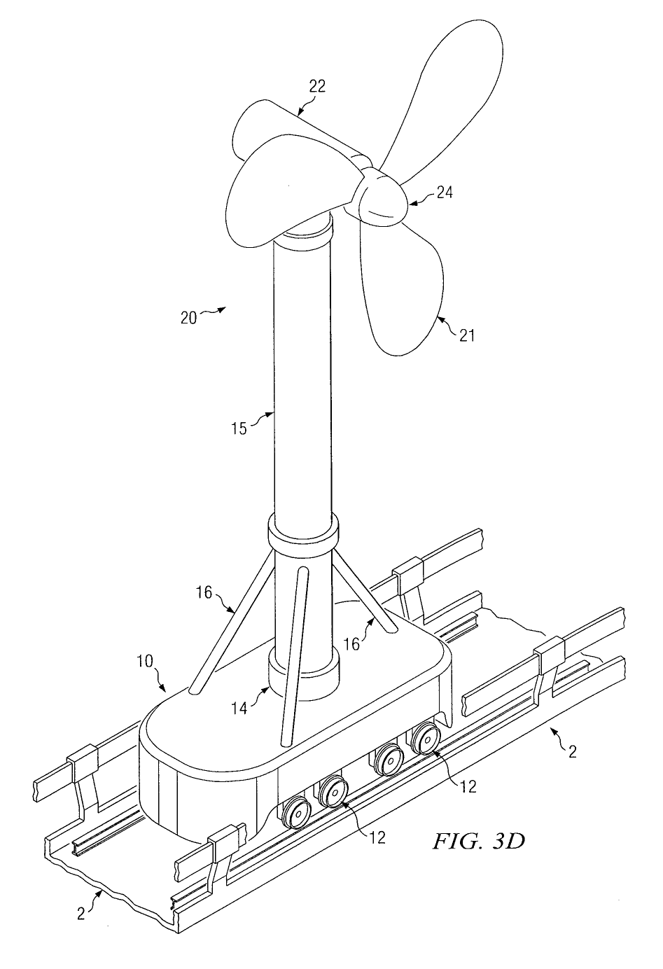

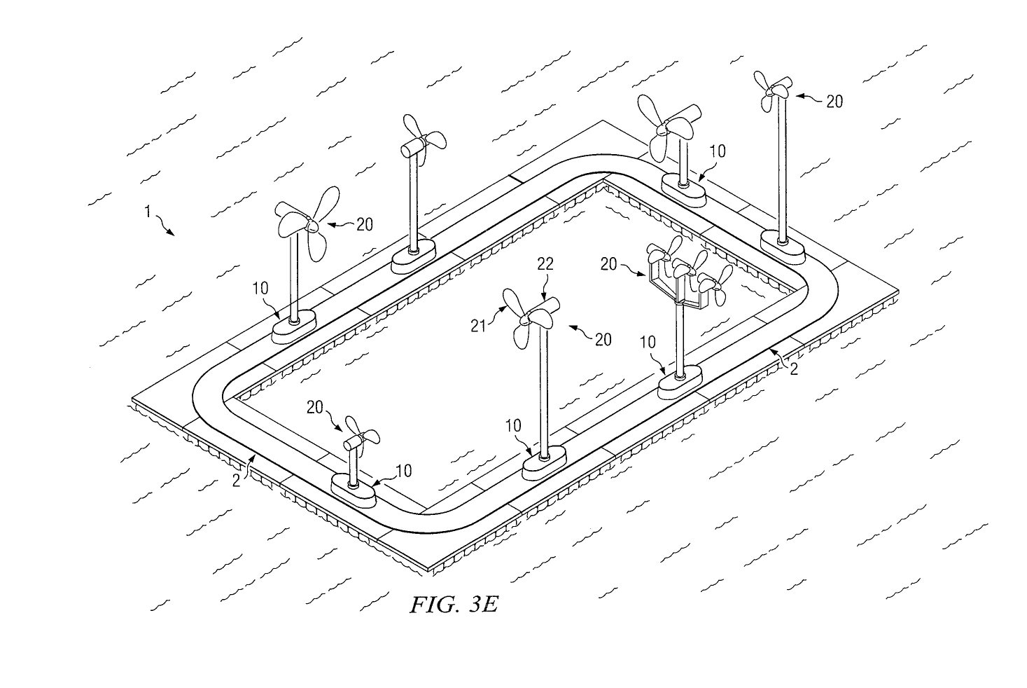

FIG. 3A illustrates an example of a runway for wheel based, preferably tire 12 based propulsion vehicles 10 with mounted wind turbines 20 moving on ground level based runway 2 or an elevated runway 2 by means of elevation support structures 3 at constant or variable speed. Said propulsion vehicles 10 can be of example type automatic propulsion vehicles (preferred) moving on the runway 2 by the aid of remote guidance sensors 4 embedded in the runway 2 or can also be manually driven [not shown].

FIG. 3B illustrates an example of a runway for wheel based, preferably tire 12 based propulsion vehicles 10 with guided runway tracks for the wheels 12 and having mounted wind turbines 20 moving on ground level based runway 2 or an elevated runway 2 by means of elevation support structures 3 at constant or variable speed. Said propulsion vehicles 10 can be of example type automatic propulsion vehicles (preferred) moving on the runway 2 by the aid of remote guidance sensors 4 embedded in the runway 2 or can also be manually driven [not shown]. Said wheel tracks 3 can be constructed with friction reducing material of the example type of glass based material.

FIG. 3C illustrates an example of a rail road track 3 based wheel propulsion vehicles 10 having mounted wind turbines 20 moving on ground level based runway 2 or an elevated runway 2 by means of elevation support structures 3 at constant or variable speed. Said propulsion vehicles 10 can be of example type automatic propulsion vehicles (preferred) moving on the runway 2 by the aid of remote guidance sensors 4 embedded in the runway 2 or can also be manually driven [not shown].

FIG. 3D illustrates a perspective view of a wheel based propulsion vehicle 10 travelling on runway 2 at constant speed or at a variable speed; the incoming wind cause the mounted turbine blades 21 to rotate due to the force exerted by the kinetic energy of the said incoming wind providing torque to generators located in the nacelle 22 thus producing electricity. The energy yield for the said wind turbine of FIG. 3D is governed by the formula 0.5 rho AV³Cₚ¹NgN_{d}; the energy yield can be computed over a defined kilo watt hour range.

FIGS. 4A, 4B, 4C, 4D, 4E and 4F illustrates example designs of turbine blades 21 designed to harness the desired power from the kinetic energy of the incoming wind while reducing wind drag. The blades can be designed to auto adjust in operation to compensate for the weather conditions and wind velocity in order to harness the maximum electricity from the kinetic energy of the incoming wind. FIG. 5A and FIG. 5B illustrates examples of transferring electricity produced by the travelling wind turbines 20.

In FIG. 5A electricity transfer wires 8 are laid below or along the runway or guideway [not shown] 2. Wires from the turbine 20 are attached to conductor groove 25 connected to collection wires 8. The conductor grooves 25 connected to turbine wires 25 harnesses the electricity generated by the wind turbine 20 to be transported by means of private and or public electricity grids for residential, commercial, industrial, agricultural and transportation use.

In FIG. 5B electricity collection wires 8 are laid on poles 7 which stand parallel to the runways or guideways [not shown] 2. Wires from the turbine 20 are attached to conductor grooves 25 connected to collection wires 8. The conductor grooves 25 connected to turbine wires harnesses the electricity generated by the wind turbine 20 to be transported by means of private and or public electricity grids for residential, commercial, industrial, agricultural and transportation use.

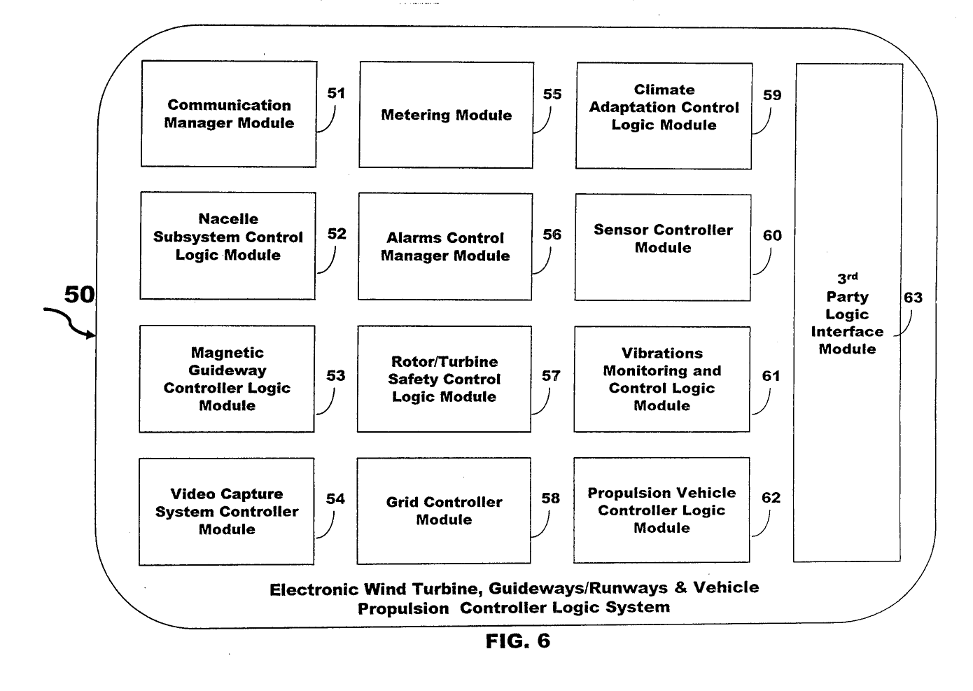

FIG. 6 is an example illustration of computer based electronic wind turbine, guideways/runways and vehicle propulsion controller logic system 50 of the renewable energy generation eco system 1 wherein the subsystems of the said controller logic 50 continuously monitors, controls and optimizes the operations of the energy generation eco system 1.

The said subsystems of the logic system 50 comprises of but not limited to the communication manager module 51, the nacelle subsystem control logic module 52, the magnetic guideway controller logic module 53, the video system controller module 54, the meter logic module 55, the alarm control manager module 56, the rotor/turbine safety control logic module 57, the grid system controller module 58, the climate adaptation control logic module 59, the system-wide sensor controller module 60, the vibrations monitoring and control logic module 61, the vehicle propulsion controller logic 62 and the 3^{rd} party logic interface module 63.

The communication manager module 51 facilitates communication amongst and between the various systems and components of the renewable energy generation eco system 1. The communication can be based on wireless communication technologies or wire-line communication technologies or a combination thereof. The communication manager module 51 facilitates uni-directional mode of communication; bi-directional mode of communication or a combination thereof between the various systems and components of the energy generation eco system 1. The communication manager 51 also includes logic to communicate with processes and systems [not shown] outside of the energy generation eco system 1.

The nacelle subsystem control logic module 52 monitors, controls and regulates the nacelle subsystems including the drive shaft, the gear train, the blade controls, nacelle hydraulics, nacelle climate control assembly, the generator subsystems, the yaw drive subsystem etc.

The magnetic guideway controller logic module 53 monitors, controls and regulates the functioning of the magnetic guideway 2.

The video system controller logic module 54 monitors, controls and regulates the functioning of the video capture system spacedly disposed across the energy generation eco system 1.

The metering module 55 tracks and monitors the flow of energy to and from the energy generation eco system 1.

The alarm control manager module 56 continuously monitors the system wide alarms and alarm parameters of the energy generation eco system 1.

The rotor/turbine safety control logic module monitors, controls and regulates the functioning of the wind turbine rotors and allied subsystems of the renewable energy generation eco system 1.

The grid controller logic module 58 monitors, controls and regulates the functioning of the electrical subsystems for transporting the electricity generated by the energy generation eco system 1 through the public and or the private grid for residential, commercial, agricultural, industrial and transportation use.

The climate adaptation control logic 59 module monitors, controls and regulates the functioning of the wind turbines 20 based on the weather conditions, wind speeds, propulsion vehicle functioning and guideway/runway conditions etc.

The sensors controller logic module 60 monitors, controls and regulates the functioning of the system wide sensors spacedly disposed across the renewable energy generation eco system 1.

The vibrations monitoring and control logic module 61 tracks and monitors turbine movement and vibrations while moving on propulsion vehicles and provides timely feedback to the eco system components for vibration adjustments.

The propulsion vehicle controller logic module 62 monitors, controls and regulates the functioning of the propulsion vehicles 10.

The third party interface module 163 provides interface for third parties to provide additional logic and intelligence for the functioning of the renewable energy generation eco system 1.

While particular embodiments are described and illustrated, the particular embodiments described and illustrated are only representative of the subject matter contemplated. The scope of the present invention encompasses embodiments that are or could become apparent to those skilled in the art, and the scope of the present invention is to be limited only by the appended claims. In the claims, reference to an element in the singular is not intended to mean one and only one, but rather one or more unless explicitly stated. The present invention encompasses all structural and functional equivalents to the elements of the embodiments described and illustrated that are known or later come to be known to those of ordinary skill in the art. Moreover, it is not necessary for a device, method, or logic to address each and every problem sought to be solved by the present invention to be encompassed by the present claims. No element, component, or method step in the described and illustrated embodiments is intended to be dedicated to the public regardless of whether the element, component, or method step is explicitly recited in the claims. No claim element herein is to be construed under the provisions of 35 U.S.C. sections 112, sixth paragraph, unless the element is expressly recited using the phrase “means for.”

What is claimed is:

1. A system comprising:
a propulsion vehicle; and
at least one wind turbine mechanically coupled to the propulsion vehicle, the at least one turbine having a rotor mechanically coupled to at least one turbine blade;
wherein motion of the propulsion vehicle induces rotation of the at least one turbine blade and the rotor.

2. The system of claim 1, further comprising an electrical generator mechanically coupled to the rotor such that rotation of the rotor induces the conversion of mechanical energy into electrical energy by the electrical generator.

3. The system of claim 2, the electrical generator configured to be electrically coupled to at least one of a public electrical grid and a private electrical grid.

4. The system of claim 1, the propulsion vehicle comprising a non-contact levitation and propulsion system.

5. The system of claim 4, wherein the propulsion vehicle is propelled by at least one of a permanent magnet, diamagnetic magnet, and a superconductive magnet.

6. The system of claim 1, the propulsion vehicle comprising a wheel-based propulsion system.

7. The system of claim 1, further comprising a controller communicatively coupled to at least one of the propulsion vehicle and the at least one wind turbine and configured to monitor and control at least one of the propulsion vehicle and the at least one turbine based on one or more operating conditions.

8. The system of claim 7, wherein the controller is configured to vary the angular position of the at least one turbine blade based on one or more operating conditions.

9. The system of claim 7, where the one or more operating conditions include at least one of: weather conditions, wind velocity, propulsion vehicle velocity; conditions of a guideway or runway upon which the propulsion vehicle operates; and electrical energy requirements of the propulsion vehicle.

10. The system of claim 7, wherein the controller is configured to control the delivery of electrical energy to at least one of a private electrical grid and a public electrical grid.

11. The system of claim 7, wherein the controller is configured to control the velocity of the propelled vehicle.

12. The system of claim 1, further comprising a video capture system operable to monitor at least one of the propulsion vehicle and the one or more wind turbines.

13. The system of claim 1, further comprising at least one of a guideway and a runway to guide the motion of the propelled vehicle.

14. The system of claim 13, wherein the guideway comprises one or more magnets disposed throughout the guideway, each of the one or more magnets coupled to a synchronous long stator motor and configured to propel the propulsion vehicle.

15. The system of claim 14, wherein a traveling magnetic field may be applied to windings of the synchronous long stator motor to propel the propulsion vehicle.

16. The system of claim 1, further comprising a tower assembly mechanically coupled to the propelled vehicle and mechanically coupled to the at least one wind turbine.

17. The system of claim 1, wherein the conversion of the kinetic energy of the air proximate to the propulsion vehicle into electricity is governed by the formula (0.5 rho AV³Cₚ¹NgN_{d}); wherein rho is an Air Density, A is a rotor swept area for various degree positioning of turbine blades, V is the velocity of the air relative to the propulsion vehicle in meters/second, Cₚ¹ is the co-efficient of performance at reference propulsion system speed, N_{g} is the generator efficiency and N_{d} is the drive train efficiency.

18. The system of claim 17 wherein the rotor swept area of a given wind turbine varies between the values of [∫₀¹ A] A and A¹.

19. The system of claim 17, wherein the co-efficient of performance of a given turbine varies between the values of Cₚ and Cₚ¹.

20. The system of claim 1, the wherein the vehicle moving at a reference speed having the turbine blades positioned at a reference position produces an electricity output within a defined kilowatt-hour rating.

21. A renewable energy eco system comprising of one or more wind turbines mounted on non-contact levitation and propulsion systems and or wheel based propulsion systems; one or more ground based guideways or suspended guideways; one or more ground based runways or suspended runways, one or more computer based wind turbine controllers; one or more computer based guideway controllers; one or more computer based propulsion system controllers, one or more computer based runway controllers, one or more video capture systems and connectivity to one or more public and or private electrical grids,
wherein the non-contact levitation and propulsion system or wheel based propulsion system mounted with one or more wind turbines move at variable or constant speeds on ground based or overhead suspended runways with the wind turbine blades locked in pre determined positions or at varying degree positions,
wherein the wind causes the mounted wind turbine blades to rotate due to its kinetic energy; the rotating wind turbine blades provide torque to generators producing electricity for residential, commercial, agricultural, industrial and transportation use.

22. The system of claim 21, wherein the propulsion system comprises of a non-contact levitation based propulsion vehicle or a wheel based propulsion vehicle or a hybrid vehicle based on non-contact levitation and propulsion technologies and wheel based propulsion technologies.

23. The system of claim 21, wherein the levitation, propulsion and control of a non contact propulsion vehicle is attained by the principles of magnetism and electro magnetism by means of one or more permanent magnets or superconductive magnets.

24. The system of claim 21, wherein the propulsion vehicle hosts a wind turbine assembly, one or more wind turbines with one or more blades, a nacelle suspended at the base or along the length of the tower assembly or placed adjacent to the rotor blades on the tower assembly, spacedly disposed connectivity to the electricity grid; and spacedly disposed video capture systems.

25. The system of claim 21, wherein a guideway comprises of location reference system and spacedly disposed magnets and synchronous long stator synchronous motors for the levitation, propulsion and control of a non contact propulsion vehicles mounted with one or more wind turbines for producing electricity.

26. The system of claim 21, wherein a runway comprises of location reference system and tracks for wheel based propulsion systems for moving the propulsion vehicle mounted with one or more wind turbines for producing electricity.

27. The system of claim 24, wherein a traveling magnetic field is generated in the windings of the long stator motor to propel one or more wind turbines mounted on the propulsion vehicle along the guideway for producing electricity.

28. The system of claim 21, wherein a non-contact propulsion system is levitated by means of conventional magnets, diamagnetic magnets, superconducting magnets or a combination thereof to propel one or more mounted wind turbines along the guideway for producing electricity.

29. The system of claim 21, wherein an electronic turbine controller controls the turbine blades to rotate at reference speeds at reference blade positions providing torque to generators converting the kinetic energy of the wind into electricity.

30. The system of claim 21, wherein a non-contact wind turbine levitation and propulsion systems or wheel based wind turbine propulsion systems can be auto propelled or can also be manually driven on ground based and or suspended guideways and runways.

31. The system of claim 21, wherein the wind turbine blades position can be preset and can also be auto adjusted to harness electricity from the kinetic energy of the wind.

32. The system of claim 30, wherein the speed of the propulsion systems can be preset and can also be automatically adjusted on given operating conditions.

33. The system of claim 21, wherein the renewable energy generation eco system is connected to a public grid and can also be connected to a private grid delivering electricity for residential, commercial, agricultural, industrial and transportation use.

34. The system of claim 21, wherein the video capture systems are spacedly disposed across the renewable energy generation eco system for monitoring.

35. The system of claim 21, wherein the wind turbine blades rotate in clock wise or counter clock wise direction; the tip of said blades aerodynamically enhanced to capture and convert the kinetic energy of the wind providing lift for the controlled rotation of the turbine blades and delivering torque to a nacelle generator producing electricity.

36. The system of claim 21, wherein a propulsion system and its mounted wind turbine assembly is aerodynamically designed to reduce drag in motion achieving controlled rotation of the turbine blades producing electricity in defined Kilo Watt Hour range.

37. The system of claim 21, wherein the tower assembly can support a plurality of wind turbines.
